(19) United States
(12) Patent Application Publication
(10) Pub. No.: US 2017/0328194 A1
(43) Pub. Date: Nov. 16, 2017

(54) AUTOENCODER-DERIVED FEATURES AS INPUTS TO CLASSIFICATION ALGORITHMS FOR PREDICTING FAILURES

(71) Applicant: University of Southern California, Los Angeles, CA (US)

(72) Inventors: Jeremy J. Liu, Arcadia, CA (US); Ayush Jaiswal, Los Angeles, CA (US); Ke-Thia Yao, Porter Ranch, CA (US); Cauligi S. Raghavendra, Redondo Beach, CA (US)

(21) Appl. No.: 15/496,995

(22) Filed: Apr. 25, 2017

Related U.S. Application Data
(60) Provisional application No. 62/327,040, filed on Apr. 25, 2016.

(51) Int. Cl. E21B 47/00; G06N 3/08

(52) U.S. Cl. CPC E21B 47/0007; G06N 3/088

(57) ABSTRACT

The invention relates to using autoencoder-derived features for predicting well failures (e.g., rod pump failures) using a machine learning classifier (e.g., a Support Vector Machine (SVMs)). Features derived from dynamometer card shapes are used as inputs to the machine learning classifier algorithm. Hand-crafted features can lose important information whereas autoencoder-derived abstract features are designed to minimize information loss. Autoencoders are a type of neural network with layers organized in an hourglass shape of contraction and subsequent expansion; such a network eventually learns how to compactly represent a data set as a set of new abstract features with minimal information loss. When applied to card shape data, it can be demonstrated that these automatically derived abstract features capture high-level card shape characteristics that are orthogonal to the hand-crafted features. In addition, experimental results show improved well failure prediction accuracy by replacing the hand crafted features with more informative abstract features.

### RELATED APPLICATIONS

This application claims the benefit of U.S. Patent Application No. 62/327,040; entitled “AUTOENCODER-DERIVED FEATURES AS INPUTS TO CLASSIFICATION ALGORITHMS FOR PREDICTING FAILURES”; filed on Apr. 25, 2016; the content of which is incorporated herein by reference.

### BACKGROUND

The invention relates to a method and system for predicting failures of an apparatus, such as well failures of a well.

### SUMMARY

In machine learning, effective classification of events into separate categories relies upon picking a good feature set to describe the data. For various reasons, dealing with the raw data's dimensionality may not be desirable so the data is often reduced to a smaller space known as a feature set. Feature sets are typically selected by subject-matter experts through experience. This disclosure describes, among other things, the use of dynamometer card shape data reduced to hand-crafted features (e.g., card area, peak surface load, and minimum surface load) to predict well failures using previously developed support vector machines (SVM) technology.

An alternate method of generating a good feature set is to pass the raw data through a type of deep neural network known as an autoencoder. Compared to selecting a feature set by hand, there are two benefits of autoencoders. First, the process is unsupervised; so, even without expertise in the data being classified, one can still generate a good feature set. Second, the autoencoder-generated feature set loses less information about the raw data than a hand-selected feature set would. Autoencoders minimize information loss by design, and the additional information preserved in autoencoder features is carried through to the classification algorithms, manifesting as improved classification results.

In the experiments described herein, two feature sets are generated from the raw dynamometer card shapes. One set is hand-selected and the other set is derived from an autoencoder. The feature sets are used to train and test a support vector machine that classifies each feature vector as a normally operating well or a well that will experience failure within the next 30 days. In an extended experiment, the results of combining the two feature sets are presented to produce a concatenated version containing both autoencoder-derived features and hand-selected features.

Other aspects of the invention will become apparent by consideration of the detailed description and accompanying drawings.

### BRIEF DESCRIPTION OF THE DRAWINGS

FIG. 1 represents an autoencoder structure composed of 9 layers.

FIG. 2 depicts an example of an autoencoder reconstruction. The original card shape (top) is composed of 30 points, and the reconstructed (also 30 points) is generated from only 3 abstract features.

FIG. 3 depicts a Restricted Boltzmann Machine.

FIG. 4 is a block diagram representing a prior art prediction system with a feature extractor.

FIG. 5 is a block diagram representing a prediction system with an autoencoder.

FIG. 6 depicts a comparison of SVM results for different feature sets.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Additionally, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. Described functionality can be performed in a client-server environment, a cloud computing environment, a local-processing environment, or a combination thereof.

Autoencoders

Autoencoders are a type of deep neural network that can be used to reduce data dimensionality. Deep neural networks are composed of many layers of neural units, and in autoencoders, every pair of adjacent layers forms a full bipartite graph of connectivity. The layers of an autoencoder collectively create an hourglass figure where the input layer is large and subsequent layer sizes reduce in size until the center-most layer is reached. From there until the output layer, layer sizes expand back to the original input size.

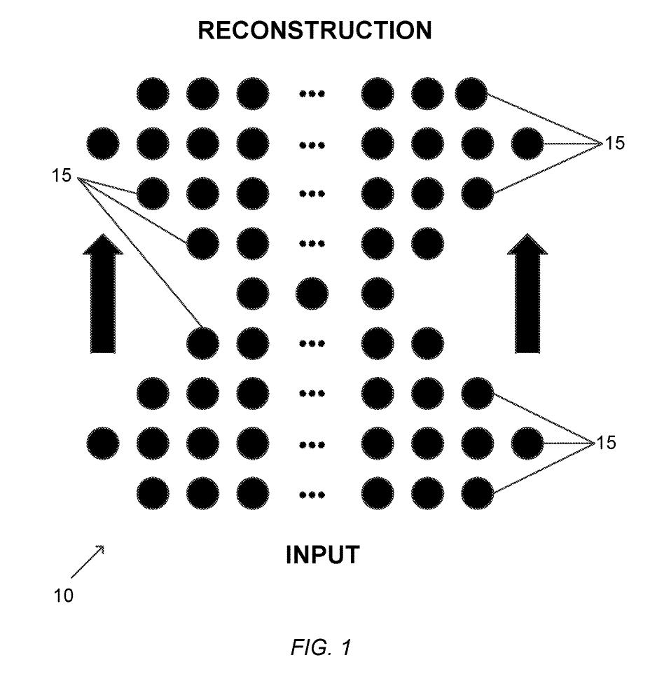

For example, FIG. 1 represents an autoencoder structure 10 composed of nine layers 15. Every layer 15 in the network 10 is fully connected with its adjacent layers. The layer sizes are 30 units (input), 60 units, 40 units, 20 units, 3 units, 20 units, 40 units, 60 units, and 30 units (output). Autoencoder-derived features are pulled from the center-most layer composed of 3 units. The number of units and layers shown with FIG. 1 are exemplary.

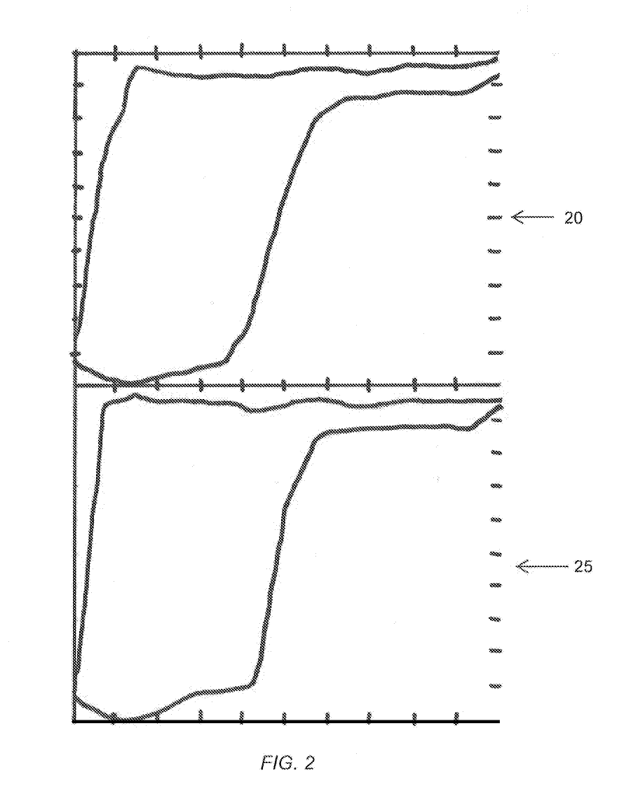

Data passed into an autoencoder experiences a reduction in dimensionality. With each reduction, the network summarizes the data as a set of features. With each dimensionality reduction, the features become increasingly abstract. (A familiar analogy is image data: originally an image is a collection of pixels, which can first be summarized as a collection of edges, then as a collection of surfaces formed by those edges, then a collection of objects formed by those surfaces, etc.). At the center-most layer, the dimensionality is at a minimum. From there, the network reconstructs the original data from the abstract features and compares the reconstruction result against the original data. Based on the error between the two, the network uses backpropagation to adjust its weights to minimize the reconstruction error. When reconstruction error is low, one can be confident that the feature set found in the center-most layer of the autoencoder still carries important information that accurately represents the original data despite the reduced dimensionality. In FIG. 2, one can see that much of the original card shape's information 20 is retained within the abstract features 25 generated by the autoencoder enough to reconstruct the original data relatively accurately.

Performing a similar reconstruction may not be feasible with hand-selected features. In one example, the hand-selected features are card area, peak surface load, and minimum surface load. Using just these three features loses some important information. For example, it would be hard to determine that gas-locking is occurring in the well pictured in FIG. 2. There are many possible card shapes one can draw that have the same card area, peak surface load, and minimum surface load, most of which will not necessarily show indications of gas-locking. But if autoencoder-derived abstract features are used and one looks at the reconstruction, such as in FIG. 2, one can see the stroke pattern that indicates that the gas-locking behavior is preserved.

Dimensionality Reduction

Reducing the dimensionality of data is helpful for many reasons. An immediately obvious application is storage: by representing data using fewer dimensions, the amount of memory required is reduced while suffering only minor losses in fidelity. While storage capacity is of less concern nowadays, limited bandwidth may still be an issue, especially in oilfields. One can look at the savings achievable with an autoencoder. Rod pumps, for example, used in this disclosure, for each card shape, transmit 30 points of position versus load. Once trained, an autoencoder can represent the 30 original values using only 3 values. Compression using autoencoders is not a lossless process, but as FIG. 2 shows, the error is small.

One may also want to avoid the curse of dimensionality in which machine learning algorithms run into sampling problems, reducing the predictive power of each training example. As the number of dimensions grows, the number of possible states (or volume of the space) grows, e.g., exponentially. Thus, to ensure that there are several examples of each possible state shown to the learning algorithm, one could provide exponentially greater amounts of training data. If we cannot provide this drastically increased amount of data, the space may become too sparse for the algorithm to produce any meaningful results.

Constructing and Training Autoencoders

The final form of an autoencoder can be built in two steps. First, the overall structure is created by stacking together several instances of a type of artificial neural network known as a Restricted Boltzmann Machine (RBM). These RBMs are greedily trained one-by-one and form the layered structure of the autoencoder. After this greedy initial training, the network begins fine-tuning itself using backpropagation across many epochs.

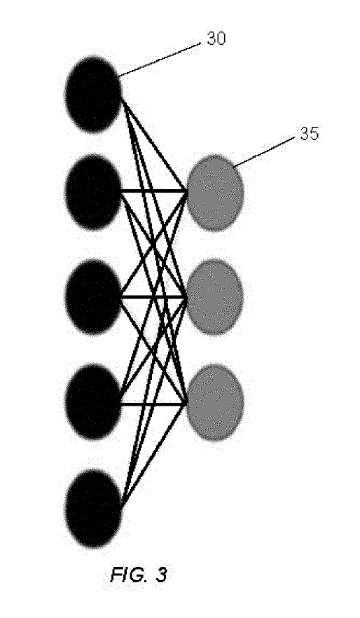

An RBM is an artificial neural network that learns a probability distribution over its set of inputs. RBMs are composed of two layers of neural units that are either “on” or “off.” Neurons in one layer are fully connected to neurons in the other layer but connections within a single layer are restricted (see FIG. 3). There are no intra-layer connections, and the network can be described as a bipartite graph. The first layer 30 is called the visible layer and the second layer 35 is called the hidden layer. This restricted property allows RBMs to utilize efficient training algorithms that regular Boltzmann Machines cannot use.

The two layers within an RBM are known as the visible and hidden layers. The goal of training an RBM is to produce a set of weights between the neural units such that the hidden units can generate (reconstruct) the training vectors with high probability in the visible layer. An RBM can be described in terms of energy, and the total energy is the sum of the energies of every possible state in the RBM. One can define the energy E of a network state v as

$$E ( v ) = - {\sum }_{i}^{ } {s}_{i}^{v} {b}_{i} - {\sum }_{i < j}^{ } {s}_{i}^{v} {s}_{j}^{v} {w}_{ij} \qquad [ E1 ]$$

where sᵢ^{v} is the binary (0 or 1) state of unit i as described by the network state v, bᵢ is the bias of unit i, and wᵢⱼ is the mutual weight between units i and j. The total energy of all possible states, then, is

$${\sum }_{u}^{ } - E ( u ) \qquad [ E2 ]$$

and one can find the probability that the network will produce a specific network state x by taking the log expression

$$P ( x ) = {e}^{- E ( x )} / {\sum }_{u}^{ } {e}^{- E ( u )} \qquad [ E3 ]$$

The method of training RBMs is known as contrastive divergence (CD). Each iteration of CD is divided into positive and negative phases. In the positive phase, the visible layer's state is set to the same state as that of a training vector (a card shape in our case). Then, according to the weight matrix describing the connection strengths between neural units, the hidden layer's state is stochastically determined. The algorithm records the resulting states of the hidden units in this positive phase. Next, in the negative phase, the hidden layer's states and the weight matrix stochastically determine the states of the visible layer. From there, the network uses the visible layer to determine the final state of the hidden units. After this, the weights can be according to the equation

Δwᵢⱼ=ε((vᵢhⱼ)_{data}−(vᵢhⱼ)_{reconstruction}) [E4]

where ε is the learning rate, <vᵢhⱼ>_{data} is the product of visible and hidden units in the positive phase, and <vᵢhᵢ>_{reconstruction} is the product of visible and hidden units in the negative phase.

Once the first RBM is trained using the CD method, all the training vectors are shown to the RBM once more and record the resulting hidden unit states are recorded corresponding to each vector. Then the next RBM in the “stack” can be moved to within the autoencoder and to the hidden states are used as input vectors into the new RBM, beginning the process anew. From there, the new RBM is trained, new hidden states are gathered, and the next RBM in line is trained. This is a greedy training method because the CD process only requires local communication between adjacent layers.

Once all RBMs in the autoencoder have been trained, the process of standard gradient descent using backpropagation begins. Normally, gradient descent requires labels to successfully backpropagate error, which implies supervised training. However, due to the function and structure of the autoencoder, the data labels happen to be the data itself: the autoencoder's goal is to accurately reproduce the data using lower dimension encodings.

Data

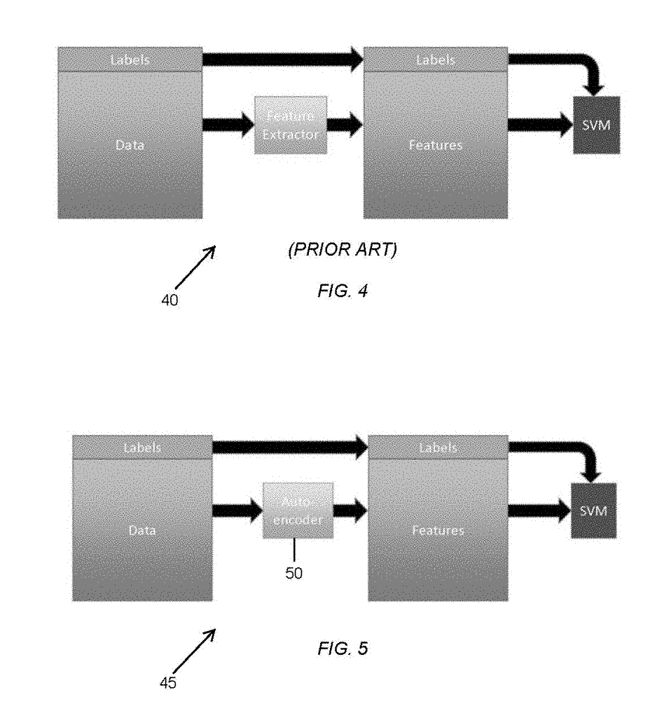

In some systems, dynamometer card shape data is two-dimensional and measures rod pump position versus load. Each oil well generates card shapes every day, and these card shapes are used to classify wells into normal and failure categories. From these card shapes, one can hand-select the following three features: card area, peak surface load, and minimum surface load. These three features are used as inputs for an SVM model. The results represent the typical case where one uses hand-selected features as inputs to the classification algorithm. FIG. 4 represents an example of this prior art system 40.

To generate a feature set derived from autoencoders, the raw data is processed first. FIG. 5 provides an example of a system 45 utilizing an autoencoder 50. In one example, one is more with the general shape of a card rather than absolute values of position or load, and because one wants to compare card shapes across many different wells, the card shapes are normalized to a unit box. Furthermore, one can interpolate points in the card shapes so that each shape contains 30 points: 15 points for the upstroke and 15 points for the downstroke.

The autoencoder used to generate the abstract features, in one example, is composed of 9 layers. The layer sizes are 30 units (input), 60 units, 40 units, 20 units, 3 units, 20 units, 40 units, 60 units, and 30 units (output/reconstruction). After autoencoder training and testing, the abstract features are collected from the center-most layer that consists of 3 units. Thus, from the original raw card shapes, a 3-feature abstract representation is chosen to pass to the SVM model (because one only wants to replace the hand-selected features). The results represent the case where autoencoder-derived features are used as inputs to classification algorithm.

A final setup in one example uses a mix of autoencoder-derived features and hand-selected features. One dataset uses 3 autoencoder features concatenated with card area, peak surface load, and minimum surface load features to generate 6-dimensional data vectors. Another reduced dataset uses 3 autoencoder features concatenated with just card area to generate 4-dimensional data vectors.

Results

Whenever a well reports downtime for any reason, it is considered a failure scenario. When the SVM model, upon reviewing a day's card shape, makes a failure prediction, one can look ahead in a 30-day window in the data to see whether there is any well downtime reported. If there exists at least one downtime day within that window, the prediction can be considered to be correct. This is how one can calculate the failure prediction precision. Furthermore, we compress failure predictions on consecutive days into a single continuous failure prediction (e.g. failure predictions made for day x, day x+1, and day x+2 would be considered a single failure classification).

For calculating the failure prediction recall, each reported failure date is examined and the 30 days preceding the failure. If there is at least one failure prediction during this period of time, the failure can be correctly predicted. Otherwise, the failure is missed.

Using the three hand-selected features (card area, peak surface load, minimum surface load), in one test implementation, the inventors obtained a failure prediction precision of 81.4% and a failure prediction recall of 86.4%.

After passing the raw data through an autoencoder to obtain three abstract features describing the shapes, the new features are used as inputs to the SVM. Under this arrangement, in one test implementation, the inventors obtained a failure prediction precision of 90.0% and a failure prediction recall of 86.1%. An expected improvement in failure prediction precision may be in the range of 10% with negligible change in failure prediction recall.

The results show that the use of autoencoder-derived features as input to an SVM produces better results than using hand-selected features. A precision improvement from 81.4% to 90.0% will almost halve the number of false alerts in a failure prediction system. At the same time, the improved precision does not come at any significant cost to recall.

Additional experiments were conducted by altering the size of our failure prediction window. The results are in Table 1 and Table 2.

TABLE 1
Precision and recall results for differing failure window sizes using
3 hand-selected features.

| | 30 days | 40 days | 50 days | 60 days |
|---|---|---|---|---|
| Precision | 81.4 | 85.0 | 99.6 | 100.0 |
| Recall | 86.4 | 88.1 | 92.9 | 97.0 |

TABLE 2
Precision and recall results for differing failure window sizes using
3 autoencoder-derived features.

| | 30 days | 40 days | 50 days | 60 days |
|---|---|---|---|---|
| Precision | 90.0 | 94.4 | 99.6 | 96.0 |
| Recall | 86.1 | 89.8 | 93.2 | 97.6 |

The learning task is more difficult with a smaller failure window due to the size of the date range in our data. The disclosed data spans half a year, so a window of 60 days already spans one-third of the data. Simply predicting failure randomly would still produce a superficially decent result. One sees that when the learning task becomes less trivial, the use of autoencoder-derived features as input to the SVM produces better precision values. Thus, additional emphasis is placed on the results of the 30-day window, where performance differences are both more relevant and more substantial.

For an extension of the previous efforts, the same procedure was repeated with hybrid feature sets consisting of autoencoder-derived features mixed with hand-selected features. The results are summarized in Table 3.

TABLE 3
Precision and recall results for differing failure window sizes using a
hybrid feature set consisting of 3 autoencoder-derived features
and 3 hand-selected features.

| | 30 days | 40 days | 50 days | 60 days |
|---|---|---|---|---|
| Precision | 65.8 | 71.1 | 78.6 | 83.0 |
| Recall | 63.3 | 63.2 | 71.0 | 75.3 |

The results of using a hybrid feature set are poor compared to using solely autoencoder features or hand-selected features. To test this, Table 4 includes the results from using 4 dimensions: 3 autoencoder features and card area.

TABLE 4
Precision and recall results for differing failure window sizes using three
autoencoder-derived features and card area for a total of 4 dimensions.

| | 30 days | 40 days | 50 days | 60 days |
|---|---|---|---|---|
| Precision | 86.7 | 87.8 | 96.5 | 99.3 |
| Recall | 86.4 | 88.9 | 93.3 | 97.2 |

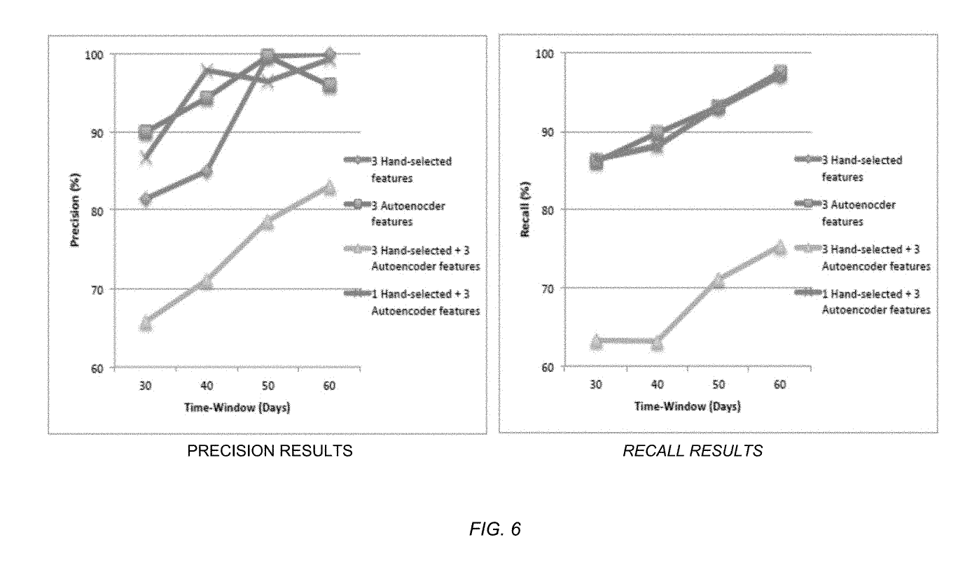

The results from using a 4-dimension mixed set are better than those from using a 6-dimension mixed set. They are still not as good as using purely autoencoder-derived features, though they do fare better than using only hand-selected features. There could be many reasons for this beyond simply dimensionality issues—attempting to combine disparate feature sets may increase the difficulty of learning, for example. FIG. 6 depicts a comparison of SVM results for different feature set.

Discussion

Despite the power of machine learning, simply throwing raw data at various algorithms will produce poor results. Picking a good feature set to represent the raw data in machine learning algorithms can be difficult: to avoid the curse of dimensionality, the feature set should remain small, yet if one uses too few dimensions to describe the data, important information that is helpful for making correct classifications in machine learning may be lost. Hand-selecting features works but requires extensive experience or experimentation with the data, which can be time-consuming or technically difficult. But if one uses autoencoders to generate feature sets, we can achieve comparable results even though the process is unsupervised.

Using autoencoder-derived features as inputs to machine learning algorithms is a generalizable technique that can be applied to most any sort of data. In one example, one uses it for dynamometer data, but in principle the technique can be applied to myriad types of data. Originally, autoencoders were applied towards pixel and image data; here it was modified for use with position and load dynamometer data. It is envisioned that it can be applied to time-series data gathered from electrical submersible pumps. If a problem involves complex, high-dimensional data and there exists potential for machine learning to provide a solution, using autoencoder-derived features as input to the learning algorithm might prove beneficial.

Accordingly, the invention provides new and useful method of predicting failures of an apparatus and a failure prediction system including the method. Various features and advantages of the invention are set forth in the following claims.

What is claimed is:

1. A method of predicting failure of an apparatus, the method being performed by a failure prediction system, the method comprising:
receiving input data related to the apparatus;
dimensionally reducing, with an autoencoder, the input data to feature data; and
providing the feature data to a machine learning classifier.

2. The method of claim 1, and further comprising
validating the feature data for maximizing prediction rate.

3. The method of claim 2, wherein validating the feature data includes utilizing backpropagation to adjust weighting in the autoencoder to minimize reconstruction error.

4. The method of claim 1, wherein the failure prediction system is a well failure prediction system, and wherein the apparatus includes a well.

5. The method of claim 1, and further comprising
dimensionally reconstructing the feature data to output data.

6. The method of claim 5, wherein dimensionally reconstructing the feature data includes dimensionally reconstructing the feature data with the autoencoder.

7. The method of claim 5, wherein the autoencoder includes an artificial neural network and the method includes defining a probability distribution to substantially relate the output data to the input data.

8. The method of claim 7, wherein defining the probability distribution includes training the artificial neural network using contrastive divergence.

9. The method of claim 7, wherein the artificial neural network includes a Restricted Boltzmann Machine.

10. The method of claim 1, wherein dimensionally reducing the input data includes performing the reduction with multiple layers.

11. The method of claim 1, wherein performing the reduction with multiple layers includes
applying the input data to a first Restricted Boltzmann Machine (RBM),
training the first RBM,
dimensionally changing the input data to first layered data with the trained first RBM,
applying the first layered data to a second RBM,
training the second RBM, and
dimensionally changing the first layered data to second layered data with the trained second RBM.

12. The method of claim 11, wherein the second layered data is the feature data.

13. The method of claim 5, wherein performing the reduction with multiple layers includes
applying the input data to a first Restricted Boltzmann Machine (RBM),
training the first RBM,
dimensionally changing the input data to first layered data with the trained first RBM,
applying the first layered data to a second RBM,
training the second RBM, and
dimensionally changing the first layered data to second layered data with the trained second RBM, and
wherein dimensionally reconstructing the feature data includes
dimensionally changing the second layered data to third layered data having a dimension similar to the first layered data, the dimensionally changing includes mirroring the first RBM,
dimensionally changing the third layered data to fourth layered data having a dimension similar to the input data, the dimensionally changing includes mirroring the second RBM.

14. The method of claim 13, wherein the further layered data is the output data.

15. The method of claim 1, wherein providing the feature data to the machine learning classifier includes communicating the feature data to a support vector machine for analysis by the support vector machine.

16. A failure prediction system comprising:
a processor; and
a memory coupled to the processor, the memory comprising program instructions which, when executed by the processor, cause the processor to
receive input data related to an apparatus, the input data for predicting a failure of the apparatus,
dimensionally reduce the input data to feature data with an autoencoder implemented by the processor,
provide the feature data to a machine learning classifier for analysis.

17. The system of claim 16, wherein the failure prediction system is a well failure prediction system, and wherein the apparatus includes a well.

18. The system of claim 16, wherein the autoencoder includes an artificial neural network wherein the memory comprising program instructions which, when executed by the processor, further cause the processor to
define a probability distribution to substantially relate the output data to the input data, and
train the artificial neural network using contrastive divergence.

19. The system of claim 18, wherein the artificial neural network includes a Restricted Boltzmann Machine.

20. The system of claim 16, wherein dimensionally reducing the input data includes the processor to perform the reduction with multiple layers.

21. The system of claim 20, wherein performing the reduction with multiple layers includes the processor to
apply the input data to a first Restricted Boltzmann Machine (RBM),
train the first RBM,
dimensionally change the input data to first layered data with the trained first RBM,
apply the first layered data to a second RBM,
train the second RBM, and
dimensionally change the first layered data to second layered data with the trained second RBM.
